(19) United States
(12) Patent Application Publication
(10) Pub. No.: US 2025/0124405 A1
(43) Pub. Date: Apr. 17, 2025

(54) CARGO LOADING OPTIMIZATION USING A CLASSICAL-QUANTUM HYBRID SYSTEM

(71) Applicant: Unisys Corporation, Blue Bell, PA (US)

(72) Inventors: Shruthi THURAVAKKATH, Bengaluru (IN); Arati SAHOO, Bengaluru (IN); Salvatore SINNO, Leeds (GB)

(21) Appl. No.: 18/916,309

(22) Filed: Oct. 15, 2024

(30) Foreign Application Priority Data
Oct. 16, 2023 (IN) 202311070269

(51) Int. Cl. G06Q 10/087

(52) U.S. Cl. CPC G06Q 10/087

(57) ABSTRACT

A hybrid approach is employed to determine an optimal packing arrangement of cargo blocks within containers loaded onto a vehicle. Cargo block data is accessed, where the cargo blocks are to be arranged into containers for transport by the vehicle having a payload area. Each cargo block is assigned to the containers subject to constraints on the cargo and the containers. A quantum annealer is invoked to individually solve an optimization problem for subsections of the payload area, where the quantum annealer determines an optimal packing arrangement of cargo blocks within the containers for each subsection of the payload area.

### CROSS-REFERENCE TO RELATED APPLICATIONS

This non-provisional patent application claims priority to Indian provisional patent application No. 20/231,1070269, filed on Oct. 16, 2023, and titled “CARGO LOADING OPTIMIZATION USING A CLASSICAL-QUANTUM HYBRID SYSTEM,” the entire contents of which is incorporated by reference herein.

### BACKGROUND

Cargo loading into containers is a process in the logistics and shipping industry, aiming to optimize the utilization of space, and the safe and secure transportation of goods. This process involves arranging various packages or items within the confines of a container in a manner that maximizes space usage, adheres to loading guidelines, and considers factors like weight distribution, accessibility, and the nature of the cargo being transported. The optimization of cargo loading directly impacts timely deliveries and the overall effectiveness of supply chain operations.

### SUMMARY

Aspects of the technology described herein relate generally to determining an optimal arrangement of cargo within a vehicle, and in particular, relates to a classical-quantum approach to determining optimal arrangements that respect a center of gravity.

To determine an optimal packing arrangement, a classical computing device may access cargo block data for cargo blocks to be arranged into containers for transport by a vehicle having a payload area. The cargo block can represent items to be arranged within containers that are loaded onto the vehicle. Each cargo block can be iteratively assigned to a container. The cargo blocks may be assigned subject to a weight constraint for the vehicle and a volume constraint for each container, such that the total weight of the cargo blocks and the containers does not exceed a vehicle threshold weight, and the total volume of the cargo blocks is less than the total volume of each respective container to which the cargo blocks are assigned.

A quantum annealer can be invoked to individually solve an optimization problem for subsections of the payload area. That is, each subsection may be loaded with a container. The optimization problem seeks to optimize the weight to determine an optimal packing arrangement of cargo blocks the containers in each subsection of the payload area. In an aspect, the optimization seeks to minimize a torque around a center of gravity created by the weight of the containers with the assigned cargo blocks.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology may be employed, in accordance with an aspect described herein;

FIG. 2 is a flow diagram illustrating an example method for generating a solution to a cargo loading problem, in accordance with an aspect described herein;

FIG. 3 is a flow diagram illustrating an example method for determining an optimal packing arrangement of cargo blocks within containers loaded onto a vehicle, in accordance with an aspect described herein;

FIG. 4 illustrates an example quantum annealer suitable for use with the present technology, in accordance with an aspect described herein;

FIG. 5 illustrates an example quantum annealing process that may be performed by the quantum annealer of FIG. 4, in accordance with an aspect described herein;

FIG. 6 illustrates an example interface for use in determining an optimal packing arrangement of cargo blocks, in accordance with an aspect described herein;

FIG. 7 illustrates an example cargo block assigner for use in determining an optimal packing arrangement of cargo blocks, in accordance with an aspect described herein;

FIG. 8 illustrates an example quantum annealer invoker for use in determining an optimal packing arrangement of cargo blocks, in accordance with an aspect described herein; and

FIG. 9 illustrates an example computing device suitable for implementing aspects of the present technology, in accordance with an aspect described herein.

### DETAILED DESCRIPTION

Cargo loading requires planning to ensure efficient operation and reduce costs during the limited time available to load. Typically, the objective is to achieve the most efficient loading of various types and shapes of containers.

Cargo optimization determines an optimal layout for arranging cargo placement within a container to maximize space utilization, maintain balance and stability, and ensure safe transportation. This optimization is used by airlines, freight forwarders, and other cargo operators to minimize costs, improve operational efficiency, and ensure the safety of both the cargo and the container.

The technology described herein leverages quantum computing and classical high-performance computing (HPC) to provide an optimal configuration bound by multiple constraints. HPC refers to the type of computing that makes use of multiple computer processors in order to perform complex computations in parallel. The technology described herein provides techniques to deal with multiple constraints to obtain an optimal solution using a hybrid approach that leverages HPC and Quantum, even when the solution space is very large.

In general, cargo loading refers to the process of organizing and placing cargo blocks into vehicles efficiently and securely, and in compliance with any vehicle requirements. It involves considerations such as weight distribution, cargo compatibility, safety regulations, and optimizing space utilization to ensure the container remains balanced.

Conventional cargo loading methods involve mathematical optimization techniques, heuristics, and machine learning approaches. These methods aim to efficiently allocate cargo, while meeting proper weight distribution, space utilization, and various other constraints. For example, integer linear programming (ILP) models are commonly used to formulate and solve load planning problems. They consider various constraints, such as weight limits, volume constraints, and balance requirements. Mixed-Integer Programming (MIP) extends ILP by allowing some variables to take non-integer values. This flexibility can improve the accuracy of the solutions. Constraint programming models are used to handle complex constraints and preferences, which are common in real-world cargo load planning. Ant colony optimization (ACO) algorithms are inspired by the foraging behavior of ants and have been applied to various optimization problems, including cargo load planning.

The present technology describes a hybrid high-performance computing/quantum-based solution to load cargo onto vehicles.

In an aspect, when loading cargo into a container that can be transported by a vehicle, loading factors can be optimized. In an aspect, factors that are optimized include the container capacity (e.g., size, weight, etc.), the transport vehicle capacity. The technology described herein involves generating an arrangement of cargos that conforms to these factors.

The technology described herein provides an arrangement of cargos that optimizes loading factors. Aspects of the technology described herein use a hybrid approach, combining HPC and quantum computing. In an embodiment, a controller and an orchestrator decompose the problem into classic and quantum parts based on the size of the problem and the constraint density, as described herein. In an aspect, the decomposition is based on a constraint density. As used herein, a constraint density is the ratio between the number of variables and the number of constraints. A constraint density is an indicator of the complexity of a problem. In an aspect, when performing decomposition of a problem (e.g., by the controller and the orchestrator), the problem is decomposed into a set of smaller problems, each with a lower constraint density. This decomposition enables the quantum provider to effectively optimize the decomposed sub-problem in the smallest amount of time. In an aspect, the quantum architecture (e.g., of the quantum provider) is limited by the maximum density ratio, which is the maximum number of variables and constraints allowed by the quantum device. In an aspect, the hybrid approach described herein uses a clustering algorithm running on an HPC platform to decompose the problem into sub-problems that can be solved using the quantum provider.

Further, the technology provides a module translation model that that allows users to describe the problem using a generic modelling language for mathematical programming, such as a mathematical programming language (AMPL), Linear programming (LP), or the like. The module translation model translates the mathematical equation for the objectives and constraints functions in a code ready to run on the quantum platform. This abstracts the complexity of developing and debugging programs written in a specific programming language (e.g., Python) or using a specific SDK (software development kit) to express the mathematical equations describing the problem in a suitable code.

In an aspect, a module translation model that that allows users to describe the problem using a generic modelling language for mathematical programming, can be used to split a problem into sub-problems for execution orchestrated between a quantum device and HPC, as described herein. As may be contemplated, although the technology described herein is described in terms of maximizing the efficiency of cargo loading by taking advantage of quantum algorithms and capabilities, the approach (e.g., optimizing problems using a hybrid approach) can be used for any model that can be expressed in AMPL or LP.

The technology described herein addresses challenges related to weight distribution, cargo compatibility, and overall space utilization for a broad range of freight solutions. The technology described herein provides a quantum-based solution that optimally arranges cargo (also referred to herein as cargo blocks), considering their weights, sizes, and other such constraints, to achieve a balanced and safe configuration that maximizes payload capacity while adhering to relevant aviation regulations.

By applying quantum algorithms and principles, the technology described herein addresses the challenges associated with cargo transportation, finding a solution across the transportation options and routes available, maximizing efficiency in packing and fuel usage, within the required safety and time constraints, among other considered objectives. The technology described herein leverages quantum computing's properties, such as superposition and entanglement, in coordination with HPC to solve complex optimization problems in cargo loading.

Aspects of the disclosed technology are used to analyze and optimally organize cargo blocks within the vehicle to meet certain vehicle requirements, such as weight distribution or center of mass requirements. In an aspect, various factors such as cargo weight, size, and compatibility are considered, ensuring a balanced distribution that maximizes payload capacity while complying with standards and regulations.

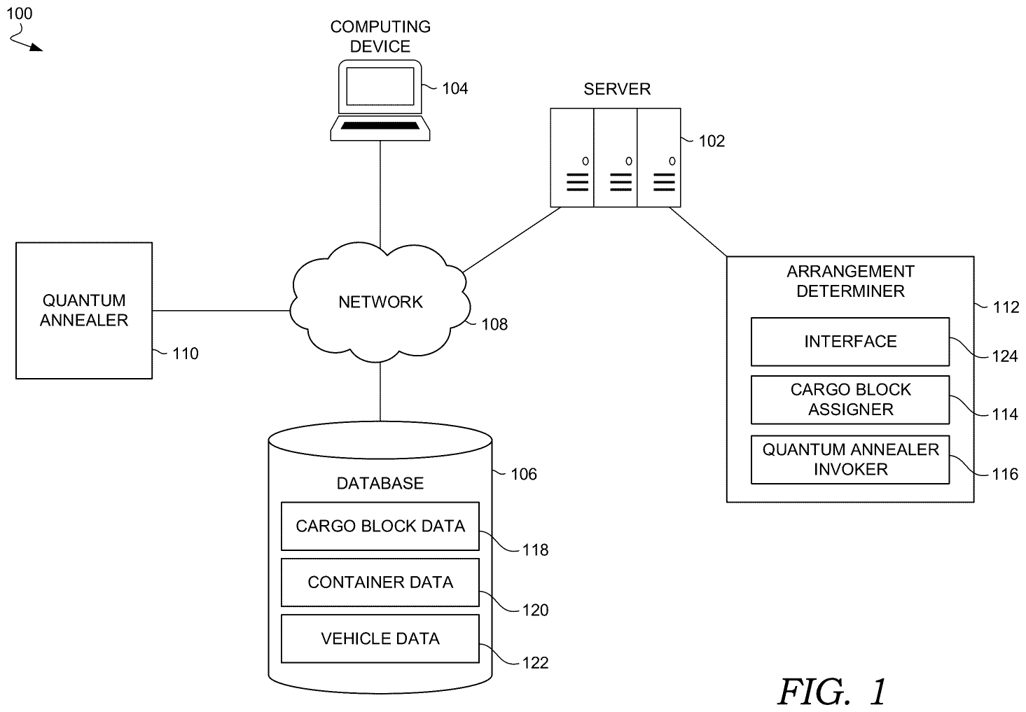

In an aspect, an AMPL/LP interface allows for complex constraints (e.g., affinity and priority) to be modeled using a modelling language, abstracting the model from the code implementation on the quantum or HPC platform. In some aspects, an interface handles the conversion from LP format into code compatible with a quantum annealer or GPU/HPC clusters and then aggregates the results to provide an optimal result and visualization, as described below, in connection with FIG. 1.

Aspects of the present technology involve transforming problem statements into an LP file format, which is then further translated into quadratic equations within a programming language's source code. In an aspect, this translated file utilizes a hybrid constrained quadratic model (CQM) and operates on a quantum annealer platform (described herein), to provide an optimal solution.

In some aspects, the technology described herein enables a larger number of qubits to be used, making it capable of providing a solution for larger cargo loading problems. In some aspects, the technology described herein (e.g., with a larger number of qubits) also executes more efficiently, as decomposing the problem into sub-problems (e.g., as described above) reduces the constraint density. This more efficiently uses computational resources to solve cargo loading problems, improving both the efficiency and speed of computing systems used to generate solutions to cargo loading problems while reducing latency. This also improves the time to generate a solution, thereby reducing latency and improving the loading of cargo.

It will be realized that the methods previously described are merely examples that can be practiced from the description that follows, and that these methods are provided to more easily understand the technology and recognize its benefits. Additional examples are now described with reference to the figures.

With reference now to FIG. 1, an example operating environment 100 in which aspects of the technology may be employed is provided. Among other components or engines not shown, operating environment 100 comprises server 102, computing device 104, database 106, and quantum annealer 110, which are communicating via network 108. In an aspect, server 102 performs arrangement determiner 112.

In an aspect, database 106 stores information, including data, computer instructions (e.g., software program instructions, routines, or services), or models used in embodiments of the described technologies. Although depicted as a single database component, database 106 may be embodied as one or more databases or may be in the cloud. In some aspects, database 106 is representative of a distributed ledger network (e.g., a system where data as replicated, shared, and synchronized over a plurality of locations that may be geographically distinct).

In an aspect, the components illustrated in block diagram 100 communicate via network 108. In an aspect, network 108 includes one or more networks (e.g., public network or virtual private network [VPN]). Network 108 may include, without limitation, one or more local area networks (LANs), wide area networks (WANs), or any other communication network or method. Such networking environments are commonplace in offices, enterprise-wide computer networks, intranets, and the internet. It should be understood that any number of user devices and servers (e.g., computing device 104 and/or server 102) may be employed within the system illustrated in block diagram 100 within the scope of the present technology. Each device or server may comprise a single device or multiple devices cooperating in a distributed environment. For instance, the arrangement determiner 112 could be provided by multiple server devices (e.g., a plurality of server 102 components) collectively providing the functionality of the arrangement determiner 112, as described herein. Additionally, other components not shown may also be included within the network environment

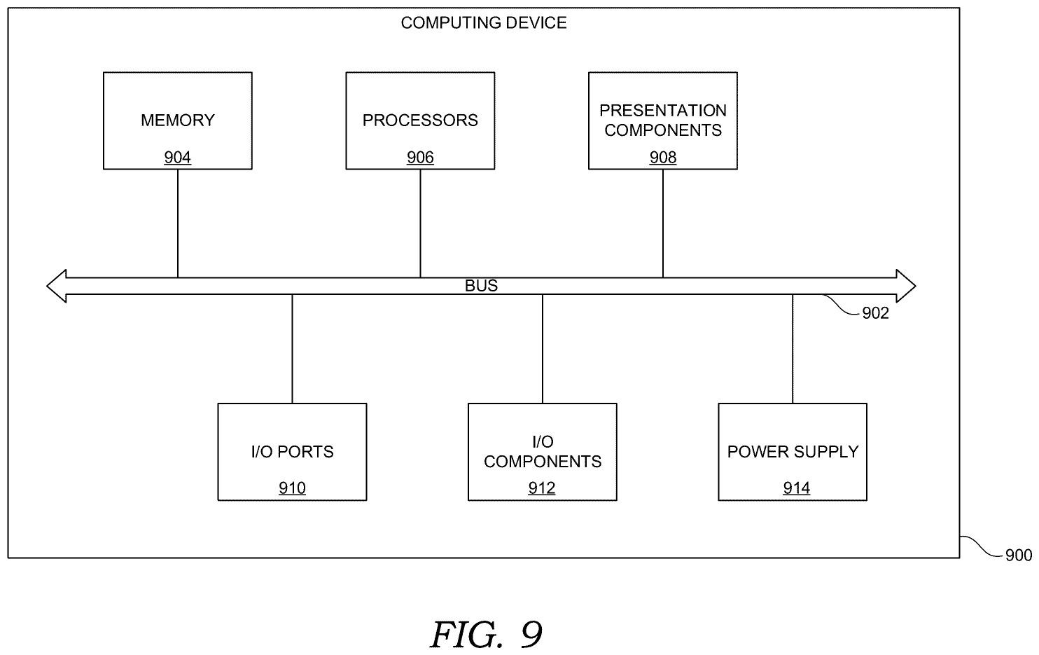

Generally, server 102 is a computing device that implements functional aspects of operating environment 100, such as one or more functions arrangement determiner 112 to optimally arrange cargo blocks within a vehicle. One suitable example of a computing device that can be employed as server 102 is described as computing device 900 with respect to FIG. 9. In implementations, server 102 represents a back-end or server-side device. In an aspect, the example operating environment 100 can comprise server-side software (e.g., executing on server 102) that is designed to work in conjunction with client-side software (e.g., on computing device 104) so as to implement any combination of the features and functionalities discussed in the present disclosure. For example, the computing device 104 can include an application (not shown in FIG. 1) for interacting with the server 102 (including the arrangement determiner 112), the quantum annealer 110, and/or the database 106). This application can be, for instance, a web browser or a dedicated application for providing functions, such as those described herein. This division of an operating environment illustrated in block diagram 100 is provided to illustrate one example of a suitable environment. There is no requirement for each implementation that any combination of the computing device 104 and the rest of the entities of block diagram 100 remain as separate entities. For example, while the operating environment illustrated in block diagram 100 illustrates a configuration in a networked environment with a separate computing device, it should be understood that other configurations can be employed in which aspects of the various components are combined. For instance, in some aspects, aspects of the various entities can be implemented in part or in whole by the computing device 104.

Computing device 104 is generally a computing device that may be used to interface with server 102. The computing device 104 may comprise any type of computing device capable of use by a user. For example, in one aspect, computing device 104 may be a computing device such as the computing device 900 described in relation to FIG. 9 herein. By way of example and not limitation, the computing device 104 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the computing device 104 and may interact with the other entities of the example operating environment 100 described in FIG. 1 (e.g., the quantum annealer 110, the database 106, the server 102, and/or the arrangement determiner 112).

In general, computing device 104 may receive inputs, such as cargo blocks to be loaded onto a vehicle, and the type of vehicle. In some aspects, computing device 104 provides cargo block data 118, container data 120, and vehicle data 122. In some aspects, computing device 104 may receive an output, such as an output providing an optimal arrangement of cargo blocks within containers for a vehicle, for display using computing device 104.

As with other components of FIG. 1, computing device 104 is intended to represent one or more computing devices. As described above, one suitable example of a computing device that can be employed as computing device 104 is described as computing device 900 with respect to FIG. 9. In implementations, computing device 104 is a client-side or front-end device. While the example architecture illustrated in FIG. 1 illustrates functions of arrangement determiner 112 being performed by server 102, it will be understood that this is just one example, and there may be more or fewer functions of arrangement determiner 112, which may be employed in various orders. It is further noted that, in some implementations of the technology, functions of arrangement determiner 112 may be performed by other components of FIG. 1, or by components not shown in FIG. 1. As an example, in some implementations, computing device 104 may be used to perform functions of arrangement determiner 112 in lieu of or in combination with server 102. The illustrated drawing is but one example used to aid in describing an aspect of the technology.

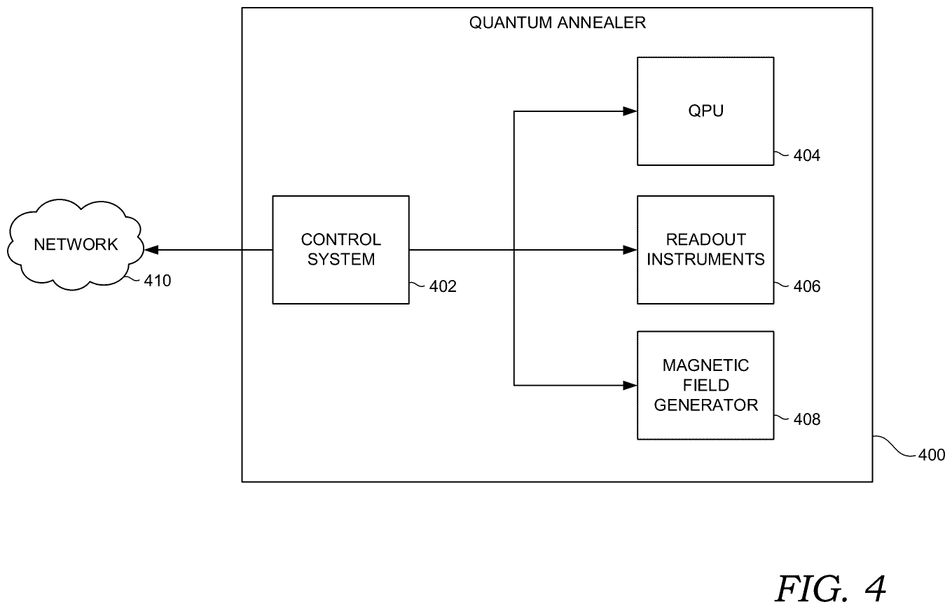

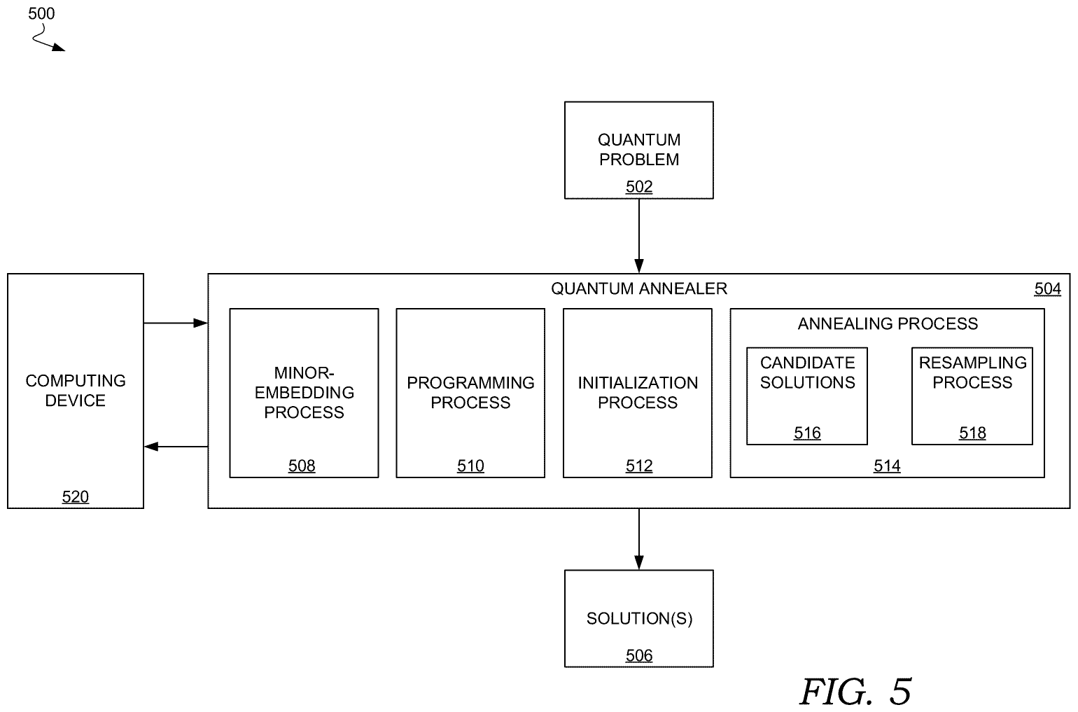

In an aspect, quantum annealer 110 comprises a quantum computing device, such as those suitable for performing quantum annealing. In an embodiment, quantum annealer 110 is an analog quantum computing device. In an aspect, quantum annealer 110 receives instructions from other components of FIG. 1 for solving a quantum problem, such as an optimization problem, as described herein. In an embodiment, quantum annealer 110 is configured to determine or receive a quantum problem and find an optimal or near-optimal solution to the problem through an annealing process, such as quantum annealing process 500, described herein in connection with FIG. 5. Quantum annealer 400, described herein in connection with FIG. 4, represents an example quantum annealer that may be suitable as quantum annealer 110.

In an aspect, arrangement determiner 112 generally determines the optimal arrangement of cargo blocks within containers for transport by a vehicle. In aspects, arrangement determiner 112 determines an optimal arrangement by invoking quantum annealer 110 to solve optimization problems and generate an optimal packing arrangement for distributing a weight of cargo blocks with a payload area in a manner that minimizes a torque around a center of gravity. In an aspect, arrangement determiner 112 comprises an interface 124, a cargo block assigner 114 and a quantum annealer invoker 116. Interface 124, cargo block assigner 114, and quantum annealer invoker 116 are described in detail below.

As used herein, a cargo block refers to an item or a group of items designated to be transported from one location to another. The term cargo block encompasses any unit for transit, including a single unit or a group of units secured or contained together. Thus, the term cargo block comprises items for transit. In aspects, cargo blocks may be loaded into containers that are placed onto a vehicle for transport.

In an aspect, database 106 includes cargo block data 118. In an aspect, cargo block data 118 may include, for example, data related to the cargo to be delivered by the vehicles, such as cargo block dimensions, (e.g., height, width, and length) cargo block volume, cargo block weight, and/or other such data.

As used herein, a container in the context of shipping refers to a vessel designed to hold and transport goods by a vehicle, such as land, sea, or air vehicle. In some aspects, a container is separate from (e.g., is transported by) a vehicle. For example, a shipping container can be transported by a truck or a train, a unit load device (ULD) can be transported by an airplane, etc. In some aspects, a container is integral to a vehicle (e.g., a container and a vehicle are the same entity). For example, a car or a pickup truck can have container space. In some cases, containers have irregular shapes. In some cases, the container shape is specific to transport by a particular type of vehicle, such as unit load devices (ULDs) designed for specific aircraft. Containers are geometric in shape and can be defined in terms of dimensions, such as length, height, and width for one or more faces of the container. Containers include a volume defined by their shape and measured by their dimensions. The base of a container generally refers to the lowest surface or boundary that encloses the space within the container from below. In some cases, a container may include a portion of a vehicle, such as if the boundaries of the vehicle itself serve as the container in which packages are directly placed. In certain context, cargo blocks may be referred to using specific industry terms. For example, in the airline industry, a container may correspond to a ULD.

In an aspect, database 106 includes container data 120. In an aspect, container data 120 may include, for example, data related to the container, such size, shape, weight requirements, container weight, container volume, boundary location of walls within the container (e.g., a volume constraint), vehicle type requirements, or other such data.

As used herein, a vehicle encompasses any mobile system capable of transporting goods, materials, or individuals across various terrains or environments, such as land, air, or sea. Vehicles include, but are not limited to, cars, trucks, airplanes, ships, drones, and autonomous vehicles, all of which facilitate the movement and delivery of cargo from one location to another. A payload area of a vehicle is a location that accepts a payload, such as cargo blocks, for transport by the vehicle. Vehicles may have one or more designated payload areas.

As described herein, vehicles have specialized weight requirements, such a weight distribution or location requirements. For instance, sea vessels may require weight to be placed lower so that the center of gravity remains low, aircraft may require that weight be distributed to maintain a specific center of gravity, while tractor trailers may require weight to be placed between axels, or other like weight requirement.

In an aspect, database 106 includes vehicle data 122. In an aspect, vehicle data 122 generally comprises data related to a vehicle. This vehicle data 122 may include the type of vehicle, the maximum carrying capacity, a weight distribution requirement, a location of a center of mass, a volume of a payload area, length of the payload area, vehicle cargo restrictions (such as restrictions on the type of cargo that can be carried by the vehicle), or other like vehicle data for receiving and transporting cargo blocks.

As described above, cargo block data 118, container data 120, and/or vehicle data 122 may be provided by and stored in database 106. In an aspect, the data is provided by computing device 104. In an aspect, other components of example operating environment may provide cargo block data 118, container data 120, and/or vehicle data 122 as well. In an aspect, data in database 106 is provided by external entities. For example, a manufacturer of a ULD may provide such data or a shipper may provide such data. In an aspect, data in database 106 is directly provided (e.g., via network 108) by such external entities. In an aspect, data in database 106 is provided by a user of computing device 104 (e.g., is manually entered from information received such as, for example, a bill of lading). In an aspect, not shown in FIG. 1, various constraints such as those described herein may be stored in database 106. As described below, arrangement determiner 112 may access database 106 to retrieve data for use by its components in determining the arrangements of packages within containers. In an aspect, arrangement determiner 112 may access database 106 via network 108.

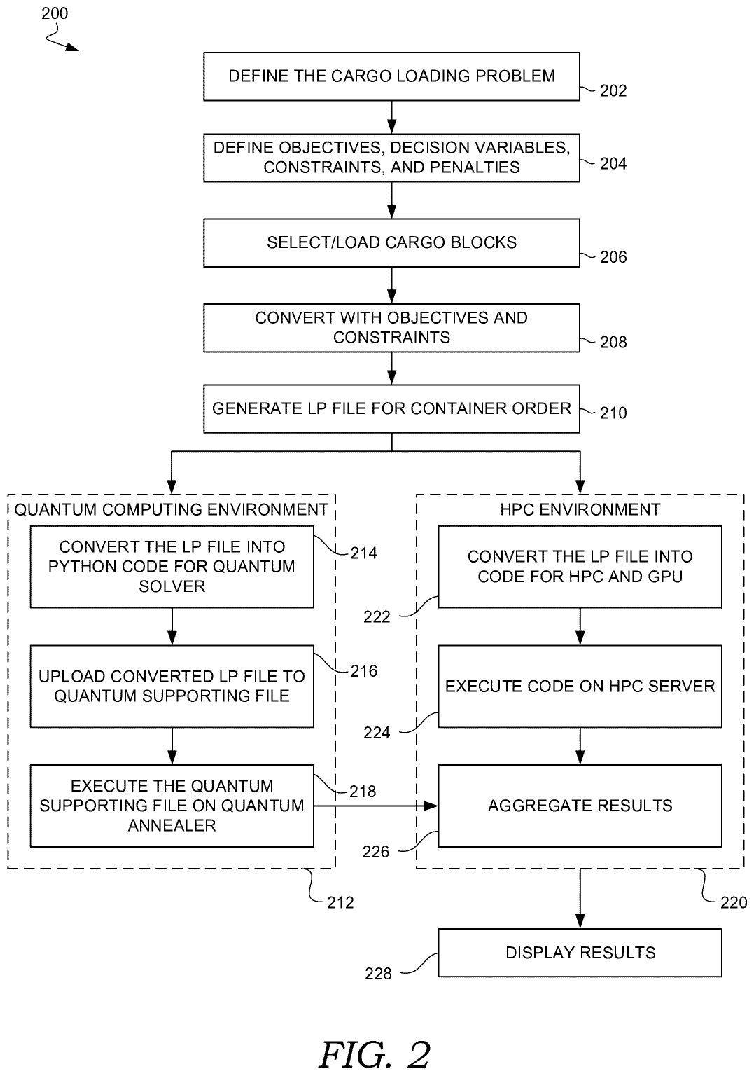

In the example illustrated, arrangement determiner 112 employs cargo block assigner 114 and quantum annealer invoker 116 to determine an optimal packing arrangement of cargo blocks within containers using quantum annealer 110. A flow diagram 200, illustrated in FIG. 2, provides an example process to determine an optimal packing arrangement of cargo blocks within containers using a quantum annealer that may be employed using arrangement determiner 112.

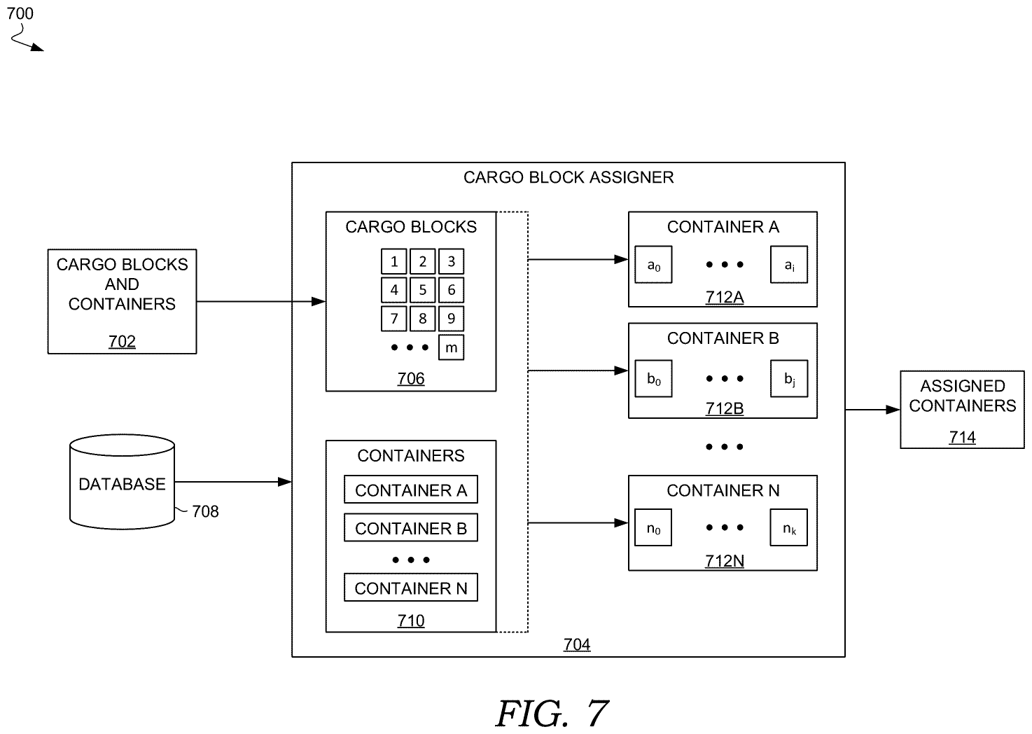

In an aspect, a cargo block assigner 114 uses the factors of cargo items (e.g., cargo weight, cargo size, container compatibility, etc.) to analyze the cargo requirements and assign the cargo items to various containers and/or vehicles. In an aspect, cargo block assigner 114, in conjunction with quantum annealer invoker 116 (described below), ensures a balanced distribution of cargo while maximizing payload capacity of containers and/or vehicles. In an aspect, cargo block assigner 114, in conjunction with quantum annealer invoker 116, uses various standards and regulations to ensure a balanced distribution of cargo while maximizing payload capacity of containers and/or vehicles. In an aspect, cargo block assigner 114 iteratively assigns cargo blocks to a container and/or a vehicle subject to the various constraints, standards, regulations, and other such factors as described herein. In an aspect, cargo block assigner 114 performs steps (or blocks) of a method illustrated in flow diagram 200. Aspects of cargo block assigner 114 are also described in connection with block 304 of flow diagram 300. Cargo block assigner 114 is described in more detail below, in connection with FIG. 7.

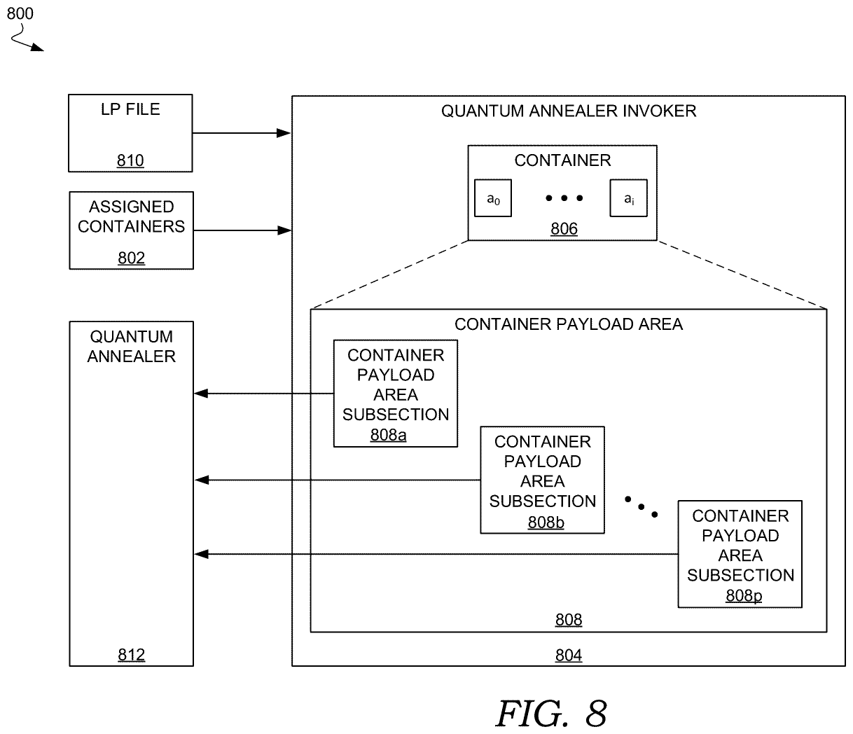

In an aspect, a quantum annealer invoker 116 receives the assigned cargo blocks (e.g., as assigned by cargo block assigner 114) and uses those assignments when invoking a quantum annealer (e.g., quantum annealer 110) to individually solve one or more optimization problems for subsections of the payload area. In an aspect, the quantum annealer invoker 116 uses a quantum annealer to determine an optimal packing arrangement of cargo blocks of the containers for each subsection of the payload area, as described herein. In an aspect, quantum annealer invoker 116 performs steps (or blocks) of a method illustrated in flow diagram 200. Aspects of quantum annealer invoker 116 are also described in connection with block 306 of flow diagram 300. Quantum annealer invoker 116 is described in more detail below, in connection with FIG. 8.

In an aspect, an interface 124 is an interface that receives a cargo loading problem. In an embodiment, interface 124 is a mathematical programming language (AMPL) interface. In an embodiment, interface 124 is a linear programming (LP) interface. In an embodiment, interface 124 is a combination AMPL/LP interface. In an embodiment, an AMPL interface receives a cargo loading problem specification (also referred to herein as a problem statement) and transforms that problem statement into a mathematical programming language (e.g., Python). In an aspect, this transformed statement is then translated into one or more equations (e.g., quadratic equations) that can use a hybrid constrained quadratic model (CQM) that can be used in a quantum environment. In an embodiment, an LP interface receives a problem statement and transforms that problem statement into a linear language that is then translated into one or more equations that can be used in a quantum environment. As used herein, an AMPL/LP interface uses one or more MPLs and LPs to receive a problem statement and transforms that problem statement into a linear language that is then translated into one or more equations that can be used in a quantum environment.

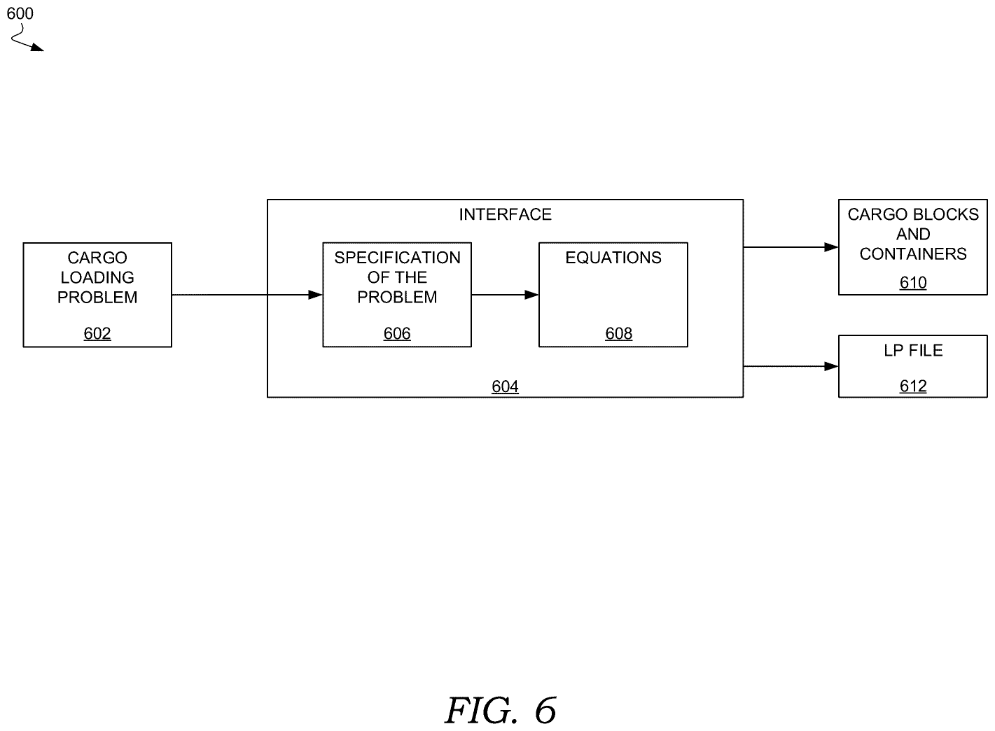

In an aspect, interface 124 (e.g., an AMPL/LP interface) can be used to model complex constraints (e.g., affinity and priority) using a modelling language. As used herein, a modelling language can be used to abstract the model (e.g., of the problem) from the code implementation on the quantum computing environment (described below in connection with FIG. 2) and the high-performance computing environment (also described below in connection with FIG. 2). By abstracting the model, a user can specify a problem in a modelling language without having to specify the problem using a specific API or SDK (e.g., written in C++, Java, etc.). In an aspect, interface 124 performs conversion from a mathematical programming language or linear programming format into code that is compatible with a quantum environment and/or code that is compatible with a high-performance computing environment. In an embodiment, interface 124 also receives and/or aggregates results from HPC and quantum environments and provides the aggregated result to a user. As may be contemplated, while interface 124 is illustrated as an aspect of arrangement determiner 112 that is performed by server 102, in some aspects, some or all of interface 124 is performed on computing device 104. In an aspect, interface 124 performs steps (or blocks) of a method illustrated in flow diagram 200. Aspects of interface 124 are also described in connection with block 302 of flow diagram 300. Interface 124 is described in more detail below, in connection with FIG. 6.

In an aspect, a cargo loading problem can be specified that includes, a description of cargo, a description of containers and/or vehicles that can be used to transport the cargo, and various constraints on loading the cargo into the container. In an aspect, a cargo loading problem can be sent from computing device 104, via network 108, to server 102. In an aspect, a cargo loading problem can be expressed as an objective function (also referred to as a criterion function, a fitness function, a cost function, a utility function, etc.) of an optimization problem. In an aspect, an objective function is optimized and this optimization is used to maximize the total weight or volume of cargo loaded onto the container, subject to constraints (e.g., that the total weight of cargo loaded onto the container must not exceed its maximum allowed weight of the vehicle or container). In an aspect, decision variables of the objective function can specify the quantity or weight of cargo allocated to each location in the container. In an aspect, penalties of the objective function can be used to penalize solutions that violate constraints or safety regulations.

In an aspect, an interface 124 can receive the objective function (or some other specification of the cargo loading problem) and can generate an AMPL or LP file. In an aspect, the interface can generate the AMPL or LP file using the cargo loading problem and/or data from database 106 (e.g., one or more of cargo block data 118, container data 120, or vehicle data 122). For example, the AMPL or LP file can be derived from a specification of the cargo blocks of a container. In an aspect, interface 124 allows a user to describe the problem using a generic modelling language for mathematical programming.

In an aspect, not shown in FIG. 1, a generic modeling language parser, such as an LP parser, can be used to convert an LP file into, for example, Python code that can be used by a quantum computing environment and/or a high-performance computing environment to generate a solution to the cargo loading problem, using systems and methods described herein. As an example, an LP parser can translate the cargo loading problem into objectives and constraints that can be used by quantum annealer 110, thereby abstracting the complexity of developing and debugging programs written in a specific programming language. In an embodiment, the cargo loading problem can be partitioned into sub-problems, which can be managed across both Quantum and HPC platforms, as described in more detail at least in connection with FIG. 2 and FIGS. 6-8. As may be contemplated, the approach described herein, while described in terms of cargo loading, is applicable other models written in AMPL or LP.

In an aspect, in order to solve the cargo loading problem, the arrangement determiner (e.g., the cargo block assigner 114 and the quantum annealer invoker 116) can be used to determine the optimal packing arrangement of cargo within the containers and/or vehicles, as described herein. In an embodiment, the constraint density of the problem is used to decompose the cargo loading problem into HPC and quantum parts based on the size of the cargo loading problem and the constraint density of the cargo loading problem, as described herein. As used herein, the constraint density is the ratio between the number of variables and the number of constraints. As used herein, the constraint density of a problem is an indicator of the complexity of a problem. In an aspect, when performing decomposition of a problem, the problem is decomposed into a set of smaller problems, each with a lower constraint density. In an aspect, the quantum architecture (e.g., of the quantum provider) is limited by the maximum density ratio, which is a measure of the maximum number of variables and constraints allowed by the quantum device. In an aspect, the constraint density can be expressed as the ratio between the total number of variables and the total number of constraints:

$$τ = \frac{N \times L}{L + N + K + 1} \qquad ( 1 )$$

where τ is a measure of the model complexity, N is the total number of cargo blocks, L is the length of the payload area, and K is the number cargo blocks (e.g., of size 2), where 0≤K≤ N. In equation (1), for the constraint density t, it is assumed the total number of variables (e.g., N×L) and the total number of constraints (e.g., N+L+K+1) is compatible with the architecture constraint of the quantum solver, as described herein. The smaller the value of t, the greater the probability that quantum annealer 110 can find a solution close to the ideal (unknown) global optimal value.

In an aspect, cargo block assigner 114 can use a sorting algorithm such as a classical knapsack algorithm. In an aspect, the cargo block assigner 114 uses the sorting algorithm to iteratively select cargo blocks and assign them to a container, according to an objective. An example objective is to maximize the value of the selected cargo blocks, while ensuring that weight and volume constraints remain unbreeched. In an aspect, a quantum annealer 110 is employed to determine cargo block placement using quantum annealing invoker 116. In an aspect, the technology described herein can be used to divide the payload area into subsections of the payload area based on specific constraints, as described herein. In an aspect, the technology described herein then proceeds to optimize each subsection individually, treating each as, for example, a loading optimization problem to position the center of gravity at a specified location while satisfying shear load constraints.

As described herein, a solution to a cargo loading problem can be found by first using a sorting algorithm (e.g., a knapsack algorithm) to select the container and then using quantum annealing for the loading of the containers and/or the subsections of the payload. In this example, the quantum annealing invoker 116 can split the payload area into subsections based on constraints and then can optimize each subsection where each subsection becomes a separate loading problem to, for example, have the center of gravity at a specific position and meet the shear load constraints.

In an aspect, a mathematical model for cargo block position assignment involves representing the placement of cargo blocks within a defined payload area or container, such as a shipping container, truck trailer, or storage area. Using the mathematical model, the goal is to optimize the arrangement of cargo items to maximize space utilization and meet specific constraints. As an illustrative example of a mathematical model for cargo block placement, given:

mᵢ: mass of the i^{th} cargo block,
bᵢ: a binary decision variable of the i^{th} cargo block,
sᵢ: size of the i^{th} cargo block,
Wₚ: maximum payload capacity of a vehicle,
L: length of the payload area, and
xᵢⱼ = 1 if cargo block i occupies position j, 0 otherwise.
Then,

| | |
|---|---|
| Maximize Σᵢ₌₁ⁿ mᵢbᵢ | (a) |
| subject to Σᵢ₌₁ⁿ mᵢbᵢ ≤ Wₚ | (b) |
| and Σᵢ₌₁ⁿ sᵢbᵢ ≤ L | (c) |

```
and
  $Minimize {\sum }_{i , j} {x}_{i j} {m}_{j} ( j - \frac{L - 1}{2} ) [ 1 - ( \frac{1}{3} ) ( {s}_{i} - \frac{1}{3} ) ( {s}_{i} - 1 ) ] \qquad ( 2 )$
  $subject to {\sum }_{i , j} {x}_{i j} {m}_{j} ( j - \frac{L - 1}{2} ) [ 1 - ( \frac{1}{3} ) ( {s}_{i} - \frac{1}{3} ) ( {s}_{i} - 1 ) ] \geq 0 \qquad ( 3 )$
```

and for all payload sections (j),

${\sum }_{i , j} {x}_{i j} [ {s}_{i} - ( \frac{2}{3} ) ( {s}_{i} - \frac{1}{2} ) ( {s}_{i} - 1 ) ] \leq 1 \qquad ( 4 )$

and for all cargo blocks (i),

${\sum }_{j = 1}^{L} {x}_{ij} - {s}_{i} - ( \frac{2}{3} ) ( 1 - {s}_{i} ) ( 2 - {s}_{i} ) = 0 \qquad ( 5 )$

| | |
|---|---|
| and for all size 2 cargo blocks (i), | |
| Σⱼ₌₁^{L} xᵢⱼj(−1)^{j} ≤ 1 | (6) |
| and, | |
| Σⱼ₌₁^{L} xᵢⱼj(−1)^{j} ≤ −1 | (7) |

Here, equation (2) is maximizing the loaded weight, which is equivalent to finding the minimum of the objective function. In equation (a), the mass of containers is maximized in the payload area by summing all the blocks which appear in the payload. This is subject to the constraint that (b) the mass of all the loaded containers is less than the maximum weight threshold for the vehicle, and (c) the size of all the blocks that appear in the payload area is less than the available positions. For equation (2), to minimize the torque around the center of gravity, minimize the torque of all the individual cargo blocks where the torque is the mass of cargo block i if cargo block i is in position j around the center point. In the equation, sᵢ is the size of the cargo block. In an illustrative example, sᵢ can be 0.5, 1 or 2, representing a cargo block that is half size, full size, or double size.

In equation (3), there is a constraint that the torque is greater or equal to 0. This ensures that the numerical calculation does not go to a maximally negative number, which is physically infeasible, as the problem is expressed as a minimization problem.

In equation (4), each payload section j has a constraint that position j can only have one cargo block (size 1), two half cargo blocks (size 0.5), or no cargo blocks. In equation (4), cargo blocks of size 2 are expressed as one cargo block of size 1 in one position and one cargo block in a neighboring position.

In equation (5), there is a constraint that for each cargo block i, the cargo block can only be in one place if it is less than size 2 (e.g., size 0.5 or size 1) and must be in two places if the cargo block is size 2.

In equations (6) and (7), there is a constraint that for each cargo block i of size 2, there is a constraint that the two positions of the cargo block must be neighboring.

FIG. 2 is a flow diagram 200 illustrating an example method for generating a solution to a cargo loading problem, in accordance with an aspect described herein. Each block of the method illustrated in flow diagram 200 may comprise a computing process performed using any combination of hardware, firmware, or software. For instance, various functions of the method illustrated in flow diagram 200 can be carried out by a processor executing instructions stored in memory. The method illustrated in flow diagram 200 can also be embodied as computer-usable instructions stored on computer storage media. The method illustrated in flow diagram 200 can be provided by a standalone application, a service or hosted service (standalone or in combination with another hosted service), or a plug-in to another product, to name a few possibilities. The method illustrated in flow diagram 200 may be implemented in whole or in part by components of operating environment 100.

At block 202 of the method illustrated in flow diagram 200, a processor performs operations to define the cargo loading problem. In some embodiments, operations to define the cargo loading problem include defining the cargo, containers used to ship the cargo, and/or vehicles used to ship the cargo or to ship the containers. In some embodiments, the cargo loading problem is defined by a user of computing device such as computing device 104, described herein at least in connection with FIG. 1. For example, a cargo loading problem can be defined with a list of cargo to be shipped, a list of available containers, and/or a list of vehicles. In some embodiments, a cargo loading problem can be defined with a list of routes that can be used to transport cargo, a list of different vehicle types, a list of different container types, and other such information. In a general sense, a cargo loading problem can be defined with a variety of different options or can be defined with a very specific configures (e.g., use a specific ULD and a specific aircraft to ship a defined cargo). In some embodiments, aspects of cargo loading problem can be loaded from a database such as database 106 (e.g., cargo block data 118, container data 120, and/or vehicle data 122). In some embodiments, repeated shipping configurations can be stored in a database 106 so that they can be reused to ship different cargo using the same shipping configuration. In some embodiments, a cargo loading problem can be expressed as an objective function, as described above. In some embodiments, a defined cargo loading problem is provided to an arrangement determiner 112 via an interface 124, described above. In some embodiments, after block 202, the method illustrated in flow diagram 200 continues at block 204.

At block 204 of the method illustrated in flow diagram 200, a processor performs operations to define objectives, define decision variables, define constraints, and/or define penalties of the cargo loading problem (e.g., as defined at block 202). In some embodiments, objectives, decision variables, constraints, and/or penalties of a cargo loading problem are defined separately from the cargo loading problem defined at block 202. In some embodiments, objectives, decision variables, constraints, and/or penalties of a cargo loading problem are fully or partially included with the definition of the cargo loading problem defined at block 202. For example, a cargo loading problem (defined at block 202) might specify a specific ULD and a specific aircraft which would necessarily include absolute constraints on payload size (e.g., per ULD and for the aircraft), number of ULDs that can be shipped in the aircraft, etc. Similarly, a cargo loading problem can include a variety of different possible containers and/or vehicles that can be used to ship the cargo and, accordingly, such a cargo loading problem can have defined decision variables (e.g., a decision of which container or vehicle is chosen) with consequent constraints based on that choice. In some embodiment, different objectives can be defined such as, for example to minimize cost, or to maximize payload, or to place cargo in certain locations, or to conserve fuel, or reduce shipping time. In some embodiments, penalties can be defined to help shape the optimization of the cargo loading problem (e.g., costs associated with certain choices). In some embodiments, a factor of a cargo loading problem can be expressed as a single objective, decision variable, constraint, or penalty. In some embodiments, a factor of a cargo loading problem can be expressed as a combination of objectives, decision variables, constraints, and/or penalties. In some embodiments, defined objectives, decision variables, constraints, and/or penalties are provided to an arrangement determiner 112 via an interface 124, described above. In some embodiments, some or all of the defined objectives, decision variables, constraints, and/or penalties are provided to an arrangement determiner 112 based on data from a database 106 (e.g., cargo block data 118, container data 120, and/or vehicle data 122), described above. In some embodiments, after block 204, the method illustrated in flow diagram 200 continues at block 206.

At block 206 of the method illustrated in flow diagram 200, a processor performs operations to select and/or load cargo blocks. In some embodiments, operations to select and/or load cargo blocks are performed by cargo block assigner 114, described above. For example, if a cargo loading problem includes a list of cargo and a particular container type, operations to select and/or load cargo blocks are performed by cargo block assigner 114 which distributes the cargo (e.g., in cargo blocks) to one or more containers of the particular container type until all cargo blocks are assigned to a container. In some embodiments, operations to select and/or load cargo blocks are performed based on the defined cargo loading problem (e.g., defined at block 202) and/or the defined objectives, decision variables, constraints, and/or penalties (defined at block 204). For example, a cargo loading problem that is to ship a defined cargo using a particular container type may perform the operations to select and/or load cargo blocks based on the type of cargo, the weight and size of the cargo, the payload of the container, the number of available containers, and other such factors. In some embodiments, after block 206, the method illustrated in flow diagram 200 continues at block 208.

At block 208 of the method illustrated in flow diagram 200, a processor performs operations to convert (or translate) the cargo loading problem (defined at block 202) and the objectives, decision variables, constraints, and/or penalties (defined at block 204) into an objective function, as described above. In some embodiments, operations to convert (or translate) the cargo loading problem and the objectives, decision variables, constraints, and/or penalties into an objective function begins with an objective function that defines the cargo loading problem and then adjusts or alters the objective function using one or more of the objectives, decision variables, constraints, and/or penalties, as described herein (e.g., using equations (a)-(c) and (2)-(7), described above in connection with FIG. 1. In some embodiments, after block 208, the method illustrated in flow diagram 200 continues at block 210.

At block 210 of the method illustrated in flow diagram 200, a processor performs operations to generate a linear programming (LP) file for a container order, as described herein. In some embodiments, operations to generate a linear programming (LP) file for a container order are performed by a quantum annealer invoker 116, described above. In some embodiments, operations to generate a linear programming (LP) file for a container order include operations to decompose the cargo loading problem into a series of sub-problems, based on subsections of a payload area of a container. In some embodiments, this decomposition is based on constraints of the quantum annealer 110, as described above. In some embodiments, as described above, the quantum architecture of the quantum annealer is limited by a maximum density ratio, which is a measure of the maximum number of variables and constraints allowed by the quantum device, as described above in equation (1), as described in connection with FIG. 1. In some embodiments, the operations to decompose the cargo loading problem into a series of sub-problems are performed at block 208, described above, when operations to convert (or translate) the cargo loading problem and the objectives, decision variables, constraints, and/or penalties into an objective function are performed. In some embodiments, after block 210, the method illustrated in flow diagram 200 continues at block 214, to perform operations using the LP file and using a quantum computing environment 212, as described in connection with FIG. 1. In some embodiments, after block 210, the method illustrated in flow diagram 200 also continues at block 222, to perform operations using the LP file and using an HPC environment 220, as described in connection with FIG. 1.

At block 214 of the method illustrated in flow diagram 200, a processor of a quantum computing environment 212 performs operations to convert the LP file (e.g., as generated at block 210) into Python code for the quantum solver, as described herein. In some embodiments, operations to convert the LP file into Python code for the quantum solver are performed by an interface 124, described above. In some embodiments, operations to convert the LP file into Python code for the quantum solver are not performed within the quantum computing environment 212 and are, instead, performed before the LP file is provided to the quantum computing environment 212 (e.g., performed between block 210 and block 216, using a processor that is outside of the quantum computing environment 212). In some embodiments, a generic modeling language parser, such as an LP parser is used to convert the LP file into Python code for the quantum solver. In some embodiments, the LP file that is converted into Python code for the quantum solver includes the entire cargo loading problem (as defined at block 202) with the objectives, decision variables, constraints, and/or penalties (as defined at block 204) for the entire payload. In some embodiments, the LP file that is converted into Python code for the quantum solver includes a subset of the cargo loading problem (as defined at block 202) and the objectives, decision variables, constraints, and/or penalties (as defined at block 204) for a subsection of the payload, as described herein. In some embodiments, after block 214, the method illustrated in flow diagram 200 continues at block 216.

At block 216 of the method illustrated in flow diagram 200, a processor of a quantum computing environment 212 performs operations to upload the LP file to a quantum supporting file (e.g., a file that can be executed by a quantum annealer, as described herein). In some embodiments, operations to upload the LP file to a quantum supporting file are operations to upload the LP file to a quantum annealer 110, described above. In some embodiments, the format of the quantum supporting file is based on the architecture of the quantum annealer 110. In some embodiments, the quantum supporting file is to solve a subset of the cargo loading problem (e.g., as described above) that are decomposed based on the quantum architecture of the quantum annealer and is limited by a maximum density ratio as described above in equation (1) (e.g., in connection with FIG. 1). In some embodiments, after block 216, the method illustrated in flow diagram 200 continues at block 218.

At block 218 of the method illustrated in flow diagram 200, a processor of a quantum computing environment 212 performs operations to execute the quantum supporting file (e.g., as uploaded at block 216) on a quantum annealer, as described above in connection with FIG. 1. In some embodiments, operations to execute the quantum supporting file on a quantum annealer are to generate an optimal solution for the cargo loading problem using quantum annealing, as described herein. In some embodiments, operations to execute the quantum supporting file on a quantum annealer are to generate an optimal solution for a subset of the cargo loading problem using quantum annealing (e.g., for a subsection of the payload), as described herein. In some embodiments, results of executing the quantum supporting file on a quantum server are provided to block 226 of HPC environment 220 for aggregation, described below. In some embodiments, when operations to execute the quantum supporting file on a quantum annealer are to generate an optimal solution for a subset of the cargo loading problem using quantum annealing (e.g., for a subsection of the payload), after block 218, quantum environment 212 may continue at block 214 to convert another LP file for the next subsection of the payload into Python code for the quantum solver, or may continue at block 216, to upload a next converted LP file to a quantum supporting file, or may continue at block 218 to execute a next quantum supporting file for the next subsection of the payload on the quantum annealer. flow diagram 200 In some embodiments, quantum environment 212 terminates after performing block 218 when, for example, all subsections of the payload have been processed. In some embodiments, quantum environment 212 waits (e.g., remains idle) after performing block 218 until HPC environment 220 has completed performing operations described below. In some embodiments, quantum environment 212 performs other operations, not illustrated in flow diagram 200, after performing block 218.

At block 222 of the method illustrated in flow diagram 200, a processor of a HPC environment 220 performs operations to convert the LP file (e.g., as generated at block 210) into code that can be executed by the HPC environment and/or graphics programming units (GPUs) of the HPC environment. In some embodiments, operations to convert the LP file into code that can be executed by the HPC environment and/or GPUs of the HPC environment are performed by an interface 124, described above. In some embodiments, operations to convert the LP file into code that can be executed by the HPC environment and/or GPUs of the HPC environment are not performed within the HPC environment 220 and are, instead, performed before the LP file is provided to the HPC environment 220 (e.g., performed between block 210 and block 224), using a processor that is outside of the HPC environment. In some embodiments, a generic modeling language parser, such as an LP parser is used to convert the LP file into code that can be executed by the HPC environment and/or GPUs of the HPC environment. In some embodiments, the LP file that is converted into code that can be executed by the HPC environment and/or GPUs of the HPC environment includes the entire cargo loading problem (as defined at block 202) with the objectives, decision variables, constraints, and/or penalties (as defined at block 204) for the entire payload. In some embodiments, the LP file that is converted into code that can be executed by the HPC environment and/or GPUs of the HPC environment includes a subset of the cargo loading problem (as defined at block 202) and the objectives, decision variables, constraints, and/or penalties (as defined at block 204) for a subsection of the payload, as described herein. In some embodiments, after block 222, the method illustrated in flow diagram 200 continues at block 224.

At block 224 of the method illustrated in flow diagram 200, a processor of a HPC environment 212 performs operations to execute code (e.g., the code converted at block 222) on an HPC server, as described herein. In some embodiments, operations to execute the code on an HPC server are to generate an optimal solution for the cargo loading problem using GPUs of the HPC environment, as described herein. In some embodiments, operations to execute the code on an HPC server are to generate an optimal solution for a subset of the cargo loading problem using GPUs of the HPC environment (e.g., for a subsection of the payload), as described herein. In some embodiments, after block 224, the method illustrated in flow diagram 200 continues at block 226.

At block 226 of the method illustrated in flow diagram 200, a processor of a HPC environment 220 performs operations to aggregate results. In some embodiments, at block 226, results of operations to execute the quantum supporting file on a quantum server performed at block 218 are aggregated with results of operations to execute the code on an HPC server performed at block 224. In some embodiments, operations to aggregate results performed at block 226 are operations to aggregate results from a plurality of iterations of block 218 and/or from a plurality of iterations of block 224. In some embodiments, operations to aggregate results performed at block 226 are operations to aggregate results from a single iteration of block 218 and a single iteration of block 224. In such embodiments, operations of block 226 may be performed multiple times (e.g., after each iteration of block 218 and/or after each iteration of block 224). For example, if a cargo loading problem is decomposed into ten sub-problems for ten subsections of the payload as described herein, block 218 may be performed ten times and block 224 may also be performed ten times. In some embodiments, block 226 is performed when both of block 218 and block 224 are complete (e.g., block 226 waits for both blocks to complete before aggregating results so that, for example, for ten subsections, block 226 is performed ten times). In some embodiments, block 226 is performed when either one of block 218 or block 224 are complete (e.g., block 226 does not wait for blocks to complete before aggregating results so that, for example, for ten subsections, block 226 is performed twenty times). In some embodiments, block 226 is performed when all iterations of block 218 and block 224 are complete (e.g., block 226 waits until all iterations are complete and is only performed once). In some embodiments, after block 226, the method illustrated in flow diagram 200 continues at block 228. In some embodiments, HPC environment 220 terminates after performing block 226 when, for example, all subsections of the payload have been processed. In some embodiments, HPC environment 220 waits (e.g., remains idle) after performing block 226 until quantum environment 212 has completed performing operations described above. In some embodiments, HPC environment 220 performs other operations, not illustrated in flow diagram 200, after performing block 226.

In some embodiments, the operations of blocks 214, 216, and 218 are performed by quantum computing environment 212 in parallel or concurrently with the operations of blocks 222, 224, and 226, performed by HPC environment 220 by, for example, a plurality of threads operating on processors of the respective computing environments. In some embodiments, operations of block 214, block 216, and/or block 218 are performed in parallel or concurrently for each subsection of a payload (e.g., for ten subsections, ten iterations of each of block 214, block 216, and/or block 218 are performed in parallel by a plurality of threads of quantum computing environment 212). In some embodiments, operations of block 222, block 224, and/or block 226 are performed in parallel or concurrently for each subsection of a payload (e.g., for ten subsections, ten iterations of each of block 222, block 224, and/or block 226 are performed in parallel by a plurality of threads of HPC environment 220).

At block 228 of the method illustrated in flow diagram 200, a processor performs operations to display the aggregated results (e.g., the results aggregated at block 226). In some embodiments, the aggregated results are displayed at a computing device 104, described above. In some embodiments, the aggregated results are a solution to the cargo loading problem and are used to load cargo according to the cargo loading problem and the objectives, decisions variables, constraints, and/or penalties. In some embodiments, after block 228, the method illustrated in flow diagram 200 terminates. In some embodiments, after block 228, the method illustrated in flow diagram 200 continues at block 202 to, for example, define a new problem.

In some embodiments, the blocks of the method illustrated in flow diagram 200 can be performed in a different order than that illustrated in FIG. 2 when, for example, the results of one block do not rely on the results of a previous blocks. In some embodiments, the blocks of the method illustrated in flow diagram 200 can be performed concurrently or in parallel by a plurality of threads operating on a computing system such as that illustrated in connection with FIG. 1.

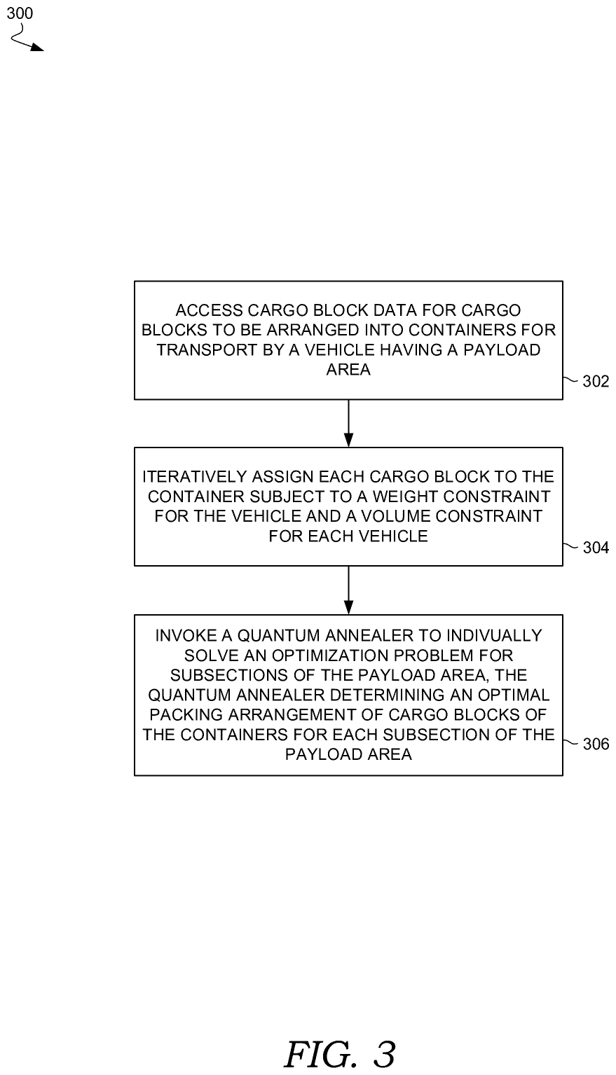

FIG. 3 is a flow diagram 300 illustrating an example method for determining an optimal packing arrangement of a vehicle, in accordance with an aspect described herein. Each block of the method illustrated in flow diagram 300 may comprise a computing process performed using any combination of hardware, firmware, or software. For instance, various functions of the method illustrated in flow diagram 300 can be carried out by a processor executing instructions stored in memory. The method illustrated in flow diagram 300 can also be embodied as computer-usable instructions stored on computer storage media. The method illustrated in flow diagram 300 can be provided by a standalone application, a service or hosted service (standalone or in combination with another hosted service), or a plug-in to another product, to name a few possibilities. The method illustrated in flow diagram 300 may be implemented in whole or in part by components of operating environment 100.

In block 302 of the method illustrated in flow diagram 300, a processor performs operations to access cargo block data for cargo blocks to be arranged into containers for transport by a vehicle having a payload area. In some embodiments, the operations to access cargo block data for cargo blocks to be arranged into containers for transport by a vehicle having a payload area are performed by components of FIG. 1. For example, operations to access cargo block data for cargo blocks to be arranged into containers for transport by a vehicle having a payload area may be performed by an arrangement determiner 112 and the cargo bock data may be accessed from cargo block data 118 in database 106, as described above. In another example, cargo block data (e.g., the cargo block data accessed at block 302) may be provided by a user of computing device 104, also as described above. In some embodiments, the operations to access cargo block data for cargo blocks to be arranged into containers for transport by a vehicle having a payload area may be performed as described in connection with one or more blocks of flow diagram 200, described above in connection with FIG. 2. In some embodiments, after block 302, the method illustrated in flow diagram 300 continues at block 304.

In block 304 of the method illustrated in flow diagram 300, a processor performs operations to iteratively assign each cargo block to the container subject to a weight constraint for the vehicle and a volume constraint for each container. In some embodiments, each cargo block is iteratively assigned to the containers using a knapsack algorithm, as described above. In some embodiments, the cargo blocks assigned are the cargo blocks to be arranged into containers for transport by a vehicle having a payload area of block 302. In some embodiments, the operations to iteratively assign each cargo block to the container subject to a weight constraint for the vehicle and a volume constraint for each container are performed by components of FIG. 1. For example, operations to iteratively assign each cargo block to the container subject to a weight constraint for the vehicle and a volume constraint for each container may be performed by a cargo block assignee, as described above. In some embodiments, the operations to iteratively assign each cargo block to the container subject to a weight constraint for the vehicle and a volume constraint for each container area may be performed as described in connection with one or more blocks of flow diagram 200, described above in connection with FIG. 2. In some embodiments, after block 304, the method illustrated in flow diagram 300 continues at block 306.

In some embodiments, not shown in FIG. 3, the method illustrated in flow diagram 300 further includes a processor performing operations to access a generic modeling language file, as described herein. In some embodiments, also not shown in FIG. 3, the method illustrated in flow diagram 300 further includes a processor performing operations to convert the modeling language file into a first computer code supported by a quantum annealer, also as described herein. In some embodiments, also not shown in FIG. 3, the method illustrated in flow diagram 300 further includes a processor performing operations to convert the modeling language file into a second computer code supported by a GPU of an HPC environment, also as described herein. In some embodiments, operations to access a generic modeling language file, operations to convert the modeling language file into a first computer code supported by a quantum annealer, and/or operations to convert the modeling language file into a second computer code supported by a GPU of an HPC environment are performed in conjunction with or after operations of block 304 to iteratively assign each cargo block to the container subject to a weight constraint for the vehicle and a volume constraint for each container. In some embodiments, operations to access a generic modeling language file, operations to convert the modeling language file into a first computer code supported by a quantum annealer, and/or operations to convert the modeling language file into a second computer code supported by a GPU of an HPC environment are performed in conjunction with or before operations of block 306 to invoke a quantum annealer to individually solve an optimization problem for subsections of the payload area, the quantum annealer determining an optimal packing arrangement of cargo blocks the containers for each subsection of the payload area, described below.

In block 306 of the method illustrated in flow diagram 300, a processor performs operations to invoke a quantum annealer to individually solve an optimization problem for subsections of the payload area, the quantum annealer determining an optimal packing arrangement of cargo blocks the containers for each subsection of the payload area. In some embodiments, an objective function for the quantum annealer minimizes torque around a center of gravity to determine the optimal packing arrangement for each subsection of the payload area. In some embodiments, the cargo blocks for which an optimal packing arrangement is to be determined are the cargo blocks iteratively assigned to the container subject to a weight constraint for the vehicle and a volume constraint for each container of block 304. In some embodiments, the operations to invoke a quantum annealer to individually solve an optimization problem for subsections of the payload area are performed by components of FIG. 1. For example, operations to invoke a quantum annealer to individually solve an optimization problem for subsections of the payload area may be performed by a quantum annealer invoker 116, as described above. In some embodiments, the operations to invoke a quantum annealer to individually solve an optimization problem for subsections of the payload area may be performed as described in connection with one or more blocks of flow diagram 200, described above in connection with FIG. 2. In some embodiments, after block 306, the method illustrated in flow diagram 300 terminates. In some embodiments, not shown in FIG. 3, after block 306, continues at block 302 to access a new set of cargo block data for cargo blocks to be arranged into containers for transport by a vehicle having a payload area.

In some embodiments, the blocks of the method illustrated in flow diagram 300 can be performed in a different order than that illustrated in FIG. 3 when, for example, the results of one block do not rely on the results of a previous blocks. In some embodiments, the blocks of the method illustrated in flow diagram 300 can be performed concurrently or in parallel by a plurality of threads operating on a computing system such as that illustrated in connection with FIG. 1.

FIG. 4 illustrates an example quantum annealer 400 that may be employed with aspects of the technology. As FIG. 4 is only one example, other quantum annealers may be employed. Some examples of which may include other annealers, employing superconducting qubits, to find the optimal or near-optimal ground state solutions to solving proposed optimization problems. As such, other quantum annealers having more of fewer components, and having different arrangements or architectures may be used. It is again, noted, that the illustrated quantum annealer 400 in FIG. 4 is only an example and is provided to aid in the description of the technology. It is not intended to limit the technology to one type of quantum annealer, or any type of quantum computing system. In the example provided, quantum annealer 400 comprises control system 402 operationally coupled to QPU 404, readout instruments 406, and magnetic field generator 408. In some aspects, quantum annealer 400 is a quantum annealer such as quantum annealer 110, described herein at least in connection with FIG. 1.

In some aspects, control system 402 of quantum annealer 400 generally interfaces with components of quantum annealer 400, including QPU 404, readout instruments 406, and magnetic field generator 408, among other components not illustrated. For instance, control system 402 may operationally control or receive information from such components. In some aspects, control system 402 facilitates quantum annealing functions, for example, translating a quantum problem into physical aspects of the QPU 404; setting parameters of the quantum annealing process, including the biases and couplings among qubits; managing the annealing schedule, a predefined protocol guiding the system from the initial to the final Hamiltonian that finds the global minimum representing the quantum problem's solution; among other functions and operations.

In some aspects, during an annealing process, control system 402 generates and delivers signals to the qubits and couplers of QPU 404, manipulating their states and interactions in accordance with the quantum problem being executed. In some aspects, as the annealing process concludes, control system 402 may oversee the readout of qubits' states in coordination with readout instruments 406, thus translating quantum information into classical data that can be interpreted by classical computing devices.

In some aspects, control system 402 communicates with one or more external systems using a network 410 (e.g., as described herein) by communicatively coupling with other computing devices, such as computing device 900 of FIG. 9, to facilitate the input of problem definitions and the output of solutions. In some aspects, control system 402 itself may comprise a classical computer processor that reads from memory to execute computer-readable instructions stored thereon.

In some aspects, QPU 404 is a Quantum Processing Unit that is the core of quantum computational activity. In some aspects, QPU 404 may house an array of qubits (quantum bits), which may exist in a superposition of states. In some aspects, QPU 404 facilitates quantum operations that exploit quantum phenomena like superposition and entanglement to solve quantum problems. In some aspects, superposition is the ability of a quantum system to be in multiple states at the time it is measured or sampled. In some aspects, entanglement is the property that the quantum state of particles in a group of particles cannot be described independently of each other, even at great spatial separation. In some aspects, QPU 404 may facilitate quantum operations that exploit other quantum phenomena. In some aspects, within QPU 404, couplers manage interactions between the qubits and form the basis for quantum logic gates and multi-qubit operations for quantum algorithms. Although not illustrated, in some aspects, QPU 404 may be cooled by a cooling device of quantum annealer 400 and shielded from other external components or interferences, helping to maintain quantum coherence.

In some aspects, QPU 404 may comprise control lines, across which signals are transmitted that guide quantum operations of QPU 404. In some aspects, QPU 404 may couple to readout instruments 406 to translate quantum states into classical data and communicate control system 402. In some aspects, readout instruments 406 may include an analog-to-converter that translates the quantum state of the qubits to the digital space, thereby identify the quantum state of the qubits in manner readable by a classical machine, and thus providing a candidate solution for the quantum problem to control system 402. In some aspects, analog signals captured from qubit measurements may be amplified and filtered to sift through and eliminate noise before being provided to readout instruments 406.

In some aspects, qubit states may be manipulated by control system 402 employing magnetic field generator 408. In some aspects, by varying the strength and orientation of the magnetic field, control system 402 can tailor the energy landscape that the qubits navigate during the annealing process. In some aspects, this magnetic field induces a bias on each qubit, influencing its tendency to take on a particular state during the annealing process.

In some embodiments, the construction of quantum computers can be approached through various paradigms and hardware setups, among which gate-based quantum computing and adiabatic quantum computation (AQC) are predominant. Gate-based computing involves executing computations by applying a series of unitary gates to quantum bits (qubits), which are then measured at the computation's conclusion. Conversely, AQC starts with a many-qubit quantum state prepared as a simple Hamiltonian's ground state, which, through adiabatic time evolution, transitions to a final Hamiltonian, encoding the solution to a targeted optimization problem. AQC and gate-based quantum computing are polynomially equivalent since quantum circuits can be depicted as a time-dependent Hamiltonian with a maximal polynomial overhead.

As used herein, quantum annealing (QA) is closely related to AQC. QA is a variant of the AQC model, employed when adiabatic conditions are unfulfilled, leading to a heuristic variational quantum algorithm. This technique is adept at identifying the ground state of Ising models, an NP-hard challenge. NP-hard and NP-complete combinatorial optimization problems can be transformed to forms suitable for quantum annealers, either framed in Ising form or as a Quadratic Unconstrained Binary Optimization (QUBO) problem. For instance, these optimization problems can be transformed to Ising form using a {−1, 1} basis and spin variables or as a QUBO problem using the {0, 1} basis and binary variables. In QA, solving a optimization problem entails progressing through multiple stages, with the specifics of each stage being influenced by the kind of qubits utilized, the adiabatic protocol implemented, and other engineering factors.

FIG. 5 illustrates an example quantum annealing process 500 utilizing a quantum annealer 504. FIG. 5 is only one example provided as an aid for understanding and using the technology described herein. In some aspects, quantum annealer 504 is a quantum annealer such as quantum annealer 400, described herein at least in connection with FIG. 4. At a high level, quantum annealer 504 receives an input, illustrated using example quantum problem 502 and outputs candidate solution(s) 506. Quantum annealing process 500 illustrates steps 508-514 (described below) that may be performed by or for quantum annealer 504 to determine solution(s) 506. For instance, some aspects may be performed by a computing device 520 communicatively coupled to quantum annealer 504. As an example, the computing device 520 may be used to facilitate aspects of minor-embedding process 508, programming process 510, initialization process 512, and/or annealing process 514 in coordination with quantum annealer 504. In an aspect, computing device 520 is a computing device such as computing device 900 described in connection with FIG. 9. In some aspects, computing device 520 may interface with a control system (e.g., control system 402) of quantum annealer 504, which may be the same or a separate computing device, as described above in connection with FIG. 4. As with other aspects of FIG. 5, each of the processes 508-518 is intended to represent an example, and is not intended to restrict the technology to a particular process or machine.

Having this in mind, quantum problem 502 may include optimization problems in various forms, such as QUBO model and an Ising model. In some aspects, real-world problems can be broken down into objectives and constraints, as described herein. Optimization problems can be represented by the following QUBO form:

$$min ( {\sum }_{i} {a}_{i} {x}_{i} + {\sum }_{i} {\sum }_{j > 1} {b}_{i , j} {x}_{i} {x}_{j} + c ) \qquad ( 8 )$$

Here, the binary variables xᵢ and xⱼ may take values from {0, 1}, and aᵢ, bᵢ, and c are constraints defined by the problem to be solved.

Optimization problems may also be expressed by the Ising model, taking the following form:

$$min ( {\sum }_{i} {h}_{i} {s}_{i} + {\sum }_{i} {\sum }_{j > 1} {J}_{i , j} {s}_{i} {xs}_{j} ) \qquad ( 9 )$$

Here, the binary variables sᵢ and sj may take values from {−1, 1}, and J_{i,j} is the interaction of two adjacent sites <i,j> for a given magnetic field hᵢ. As may be contemplated, the QUBO form and the Ising form may be translated from one another in some cases.

In some aspects, the models may be represented by a logical graph. For example, for a QUBO problem, each node may correspond to a variable which may correspond to qubits and edges of this graph represent the interaction terms between pairs of variables, derived from the quadratic terms in the QUBO expression. Similarly, for an Ising model, each node may represent a spin and correspond to qubits and edges may denote the interactions between pairs of spins (or variables) as dictated by the interaction terms in the Ising model's energy expression. Such models may be formulated or represented as logical graph and provided as a quantum problem 502 to quantum annealer 504.

In some aspects, during minor-embedding process 508 the local graph of the initial quantum problem 502 may be translated onto the physical hardware of the QPU (e.g., QPU 404). Here, select sets of physical qubits represent the nodes, while couplings between the qubits (e.g., the edges) correspond to the interaction of the logical variables

In some aspects, during programming process 510 the quantum annealer 504 may be programmed with the parameters that define the problem. This problem may be the final Hamiltonian. As used herein the final Hamiltonian is a quantum mechanical operator that represents the problem to be solved in a form that quantum annealer 504 can utilize to generate a solution. In some aspects, the final Hamiltonian is derived from the logical representation of the problem (such as the QUBO formulation or the Ising model). The objective here is to find the state (or configuration of qubits) that minimizes its energy as this corresponds to the solution of quantum problem 502.

In some aspects, the programming process 510 may comprise setting weights for each qubit bias and coupler strength. Qubits in quantum annealer 504 can have a bias, for example a term in the final Hamiltonian that represents an external magnetic field acting on the qubit. Setting the bias on a qubit influences its tendency to take a particular state (0 or 1). Weights for the qubit bias may be set based on the problem formulation to guide quantum annealer 504 toward the solution. In some aspects, couplers may comprise elements in quantum annealer 504 that control the interaction between pairs of qubits. In some aspects, the strength of a coupler determines the extent to which the state of one qubit influences the state of another. In some aspects, coupler strength may be set to represent the interactions between variables in quantum problem 502.

In some aspects, during initialization process 512, an initial Hamiltonian may be defined. The initial Hamiltonian may be constructed to have an achievable lowest energy (ground state) configuration. In some aspects, this definition of initial Hamiltonian serves as a starting point for the annealing process 514.

In some aspects, through annealing process 514, quantum annealer 504 transitions from the initial Hamiltonian to the final Hamiltonian (which was defined during the programming phase and represents the problem to be solved). Generally, as the system transitions, quantum annealer 504 attempts to maintain the lowest-energy configuration, and ideally end in the ground state of the final Hamiltonian, which corresponds to the solution of the quantum problem 502. In some cases, annealing process 514 can also be combined with a reverse annealing phase, which initializes quantum annealer 504 with a known (classical) solution and searches the state space around this solution which represents local optimum solution.

In some aspects, at the end of annealing process 514, quantum annealer 504 provides candidate solutions 516 (e.g., possible solutions to quantum problem 502). Here, the qubits in the QPU are in an eigenstate or a superposition of eigenstates with respect to the final Hamiltonian. An eigenstate refers to a state with a well-defined energy and represents a possible solution. A superposition of eigenstates refers to multiple eigenstates at once, each representing a potential solution to the problem. Each qubit's spin (either up or down) is read out, and the collection of spin values represents a candidate solution to quantum problem 502.

It should be noted that quantum annealing is heuristic and the exact optimal solution (ground state of the final Hamiltonian) may not be found in every run. Instead, the candidate solutions 516 can provide a good enough solution in a reasonable amount of time. Naturally, there's a non-zero probability of ending up in a non-optimal solution due to various quantum phenomena like tunneling and thermal fluctuations. As such annealing process 514 may undergo resampling 518, which repeats the annealing process 514 in an effort to identify a better solution than prior candidate solutions 516. Each resampling process provides a new opportunity for the quantum annealer 504 to explore the solution space and possibly find a better or different candidate solution. Resampling 518 may be performed as many times as desired, as time and continued benefit allow. By comparing candidate solutions 516, the best candidate solution or even a variety of candidate solutions may be chosen as solutions to quantum problem 502 and output as final solution(s) 506.

FIG. 6 is a block diagram 600 illustrating an example interface 604 for use in determining an optimal packing arrangement of cargo blocks, in accordance with an aspect described herein. In an embodiment, interface 604 is an interface such as interface 124, described herein at least in connection with FIG. 1. In an embodiment, a cargo loading problem 602 is provided to interface 604, as described herein. For example, cargo loading problem 602 can include specification of cargo, cargo blocks, containers, vehicles, objectives, decision variables, constraints, penalties, and/or other aspects of a cargo loading problem including, but not limited to, those described herein. In an aspect, interface 604 receives cargo loading problem 606 and performs one or more operations, such as described herein, to generate a specification of the problem 606. In an aspect, specification of the problem 606 is an LP representation of the problem, as described herein at least in connection with FIG. 1 and FIG. 2. In an aspect, interface 604 then uses specification of the problem 606 to generate one or more equations 608 (e.g., quadratic equations). In an aspect, interface 604 performs operations to specify cargo blocks and containers 610, used by a cargo block assigner 704, described below. In an aspect, interface 604 performs operations to generate an LP file, used by quantum annealer invoker 804, described below.

FIG. 7 is a block diagram 700 illustrating an example cargo block assigner 704 for use in determining an optimal packing arrangement of cargo blocks, in accordance with an aspect described herein. In an aspect, cargo block assigner 704 is a cargo block assigner such as cargo block assigner 114, described herein at least in connection with FIG. 1. In an aspect cargo block assigner 704 receives cargo blocks and containers 702 (e.g., cargo blocks and containers 610, generated by interface 604). In an aspect, cargo blocks and containers 702 comprises cargo blocks 706 and containers 710. In the example illustrated in FIG. 7, cargo blocks 706 includes cargo blocks “l” to “m” and containers 710 includes containers “A” to “N.” In an aspect, cargo block assigner 704 assigns cargo blocks to containers so that, for example, container “A” 712A is assigned cargo blocks a₀ to aᵢ of cargo blocks 706, container “B” 712B is assigned cargo blocks b₀ to bⱼ of cargo blocks 706, and container “N” 712N is assigned cargo blocks n₀ to nₖ of cargo blocks 706. In an aspect, each of container “A” 712A, container “B” 712B, and container “N” 712N has cargo blocks assigned according to data in database 708, which is a database such as database 106 that includes cargo block data 118, container data 120, vehicle data 122, and/or other such data, as described herein at least in connection with FIG. 1. In an aspect, assigned cargo block assigner 704 provides assigned containers 714 (e.g., the assignment of cargo blocks to containers) to quantum annealer invoker 804, described below.

FIG. 8 is a block diagram 800 illustrating an example quantum annealer invoker 804 for use in determining an optimal packing arrangement of cargo blocks, in accordance with an aspect described herein. In an aspect, quantum annealer invoker 804 is a quantum annealer invoker such as quantum annealer invoker 116, described herein at least in connection with FIG. 1. In an aspect, quantum annealer invoker receives assigned containers 802 from a cargo block assigner such as cargo block assigner 704 and an LP file 810 from an interface such as interface 604. In an aspect, quantum annealer invoker 804 selects a container 806, a container of assigned containers 802, that includes cargo blocks a₀ to aj. In an aspect, container 806 includes a container payload area 808. In an aspect, quantum annealer invoker 804 selects a first container payload subsection 808a (e.g., with assigned cargo blocks) and uses quantum annealer 812, which is a quantum annealer such as quantum annealer 110, to generate an optimized solution for cargo block placement of cargo blocks in container payload area subsection 808a, as described herein. In an embodiment, quantum annealer invoker 804 uses some or all of LP file 810 to use quantum annealer 812 to generate an optimized solution for cargo block placement of cargo blocks in container payload area subsection 808a. In an aspect, quantum annealer invoker 804 then selects a next container payload area subsection (e.g., container payload area subsection 808b) and uses quantum annealer 812 to generate an optimized solution for cargo block placement of cargo blocks in container payload area subsection 808b. In an aspect, quantum annealer invoker 804 continues selecting container payload area subsections and uses quantum annealer 812 to generate an optimized solution for cargo block placement of cargo blocks in the selected container payload area subsections until the last container payload area subsection 808p is selected and processed. In an aspect, not shown in FIG. 8, the results of generating the optimized solutions for the cargo block placement of cargo blocks in the selected container payload area subsections 808a to 808p are aggregated to provide a solution for the cargo loading problem 602, as described above.

Having described an overview of some embodiments of the present technology, an example computing environment in which embodiments of the present technology may be implemented is described below in order to provide a general context for various aspects of the present technology. Referring now to FIG. 9 in particular, an example operating environment for implementing embodiments of the present technology is shown and designated generally as computing device 900. Computing device 900 is but one example of a suitable computing environment and is not intended to suggest any limitation as to the scope of use or functionality of the technology. Computing device 900 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant or other handheld device. Generally, program modules, including routines, programs, objects, components, data structures, etc., refer to code that performs particular tasks or implements particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 9, computing device 900 includes bus 902, which directly or indirectly couples the following devices: memory 904, one or more processors 906, one or more presentation components 908, input/output (I/O) ports 910, input/output components 912, and illustrative power supply 914. Bus 902 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 9 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 9 and with reference to “computing device.”

Computing device 900 typically includes a variety of computer-readable media. Computer-readable media can be any available media that can be accessed by computing device 900 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 900. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 904 includes computer-storage media in the form of volatile or non-volatile memory. The memory may be removable, non-removable, or a combination thereof. Example hardware devices include solid-state memory, hard drives, optical-disc drives, etc. Computing device 900 includes one or more processors that read data from various entities, such as memory 904 or I/O components 912. Presentation component(s) 908 presents data indications to a user or other device. Example presentation components include a display device, speaker, printing component, vibrating component, etc.

I/O ports 910 allow computing device 900 to be logically coupled to other devices, including I/O components 912, some of which may be built in. Illustrative components include a microphone, joystick, game pad, satellite dish, scanner, printer, wireless device, etc. The I/O components 912 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 900. Computing device 900 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 900 may be equipped with accelerometers or gyroscopes that enable detection of motion. The output of the accelerometers or gyroscopes may be provided to the display of computing device 900 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, functional components of FIG. 1 can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to arrangement determiner 112, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of arrangement determiner 112, among other functions, may be performed by server 102, computing device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving,” or “transmitting,” as facilitated by software or hardware-based buses, receivers, or transmitters” using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “computing device” is intended to refer to a classical computing device, such as computing device 900 of FIG. 9. Other related terms, including “client device,” “server,” and the like are similarly intended to refer to a classical computing device. Terms that include “quantum” are intended to refer to a quantum computing device, such as a quantum annealer. An example quantum computing device is illustrated and described with respect to FIG. 4.

An optimal solution (also referred to as optimal packing arrangement), as described herein is intended to be the most favorable solution derived from a set of potential solutions generated within the constraints of available processing power and time. This solution minimizes or maximizes the defined objective(s) based on the data and algorithms employed during the computational process, such as the annealing process. It represents the best solution among those explored, within the computational resources allocated, to solve the optimization problem and achieve the desired logistical outcome. While it may not represent the absolute best solution possible due to limitations in computational resources, data accuracy, or physical interferences, it stands as the most efficient or effective solution identified through the computational process undertaken for a given set of parameters.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well adapted to attain all the ends and objects described above, including other advantages that are obvious or inherent to the structure. It will be understood that certain features and sub-combinations are of utility and may be employed without reference to other features and sub-combinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

What is claimed is:

1. A computer-implemented method comprising:
accessing cargo block data of one or more cargo blocks, the cargo blocks to be arranged into one or more containers for transport by a vehicle having a payload area;
assigning each cargo block of the one or more cargo blocks to a container of the one or more containers based, at least in part, on one or more constraints; and
invoking a quantum annealer to generate one or more solutions to one or more optimization problems for subsections of the payload area, the solutions usable to determine a packing arrangement of the one or more cargo blocks within the one or more containers for each subsection of the payload area.

2. The computer-implemented method of claim 1, wherein assigning the one or more cargo blocks to the one or more containers comprises iteratively assigning the one or more cargo blocks to the one or more containers using a knapsack algorithm.

3. The computer-implemented method of claim 1, wherein the quantum annealer generates the solutions to the one or more optimization problems based, at least in part, on an objective function that minimizes torque around a center of gravity to determine the optimal packing arrangement for each subsection of the payload area of the container.

4. The computer-implemented method of claim 1, further comprising:
accessing a generic modeling language file; and
converting the generic modeling language file into a computer code supported by the quantum annealer.

5. The computer-implemented method of claim 1, further comprising:
accessing a generic modeling language file; and
converting the generic modeling language file into a computer code supported by a high-performance computing (HPC) environment.

6. The computer-implemented method of claim 1, wherein the subsections of the payload area are determined based, at least in part, on a constraint density of the quantum annealer.

7. The computer-implemented method of claim 1, wherein the quantum annealer generates the solutions to the one or more optimization problems based, at least in part, on an objective function that maximizes a loaded weight of each subsection of the payload area subject to a constraint that a sum of the loaded weight of the subsections is less than a maximum weight threshold of the vehicle.

8. The computer-implemented method of claim 1, wherein the quantum annealer generates the solutions to the one or more optimization problems based, at least in part, on one or more constraints on a size of each of the one or more cargo blocks.

9. The computer-implemented method of claim 1, further comprising:
aggregating the one or more solutions to the one or more optimization problems for subsections of the payload area to generate a packing arrangement of the one or more cargo blocks within the vehicle.

10. The computer-implemented method of claim 1, further comprising:
defining the one or more optimization problems using a linear programming (LP) file;
determining whether to generate the one or more solutions to the one or more optimization problems using a high-performance computing (“HPC”) environment;
when determining to generate the one or more solutions to the one or more optimization problems using the HPC environment, converting the LP file to HPC code for a graphics processing unit (“GPU”);
executing the converted code using the GPU of the HPC to generate a solution; and
aggregating the generated solution with one or more other generated solutions.

11. A computer system comprising:
at least one processor; and
one or more computer storage media storing computer readable instructions thereon that when executed by the at least one processor cause the at least one processor to perform operations comprising:
accessing cargo block data of one or more cargo blocks, the cargo blocks to be arranged into one or more containers for transport by a vehicle having a payload area;
assigning each cargo block of the one or more cargo blocks to a container of the one or more containers based, at least in part, on one or more constraints; and
invoking a quantum annealer to generate one or more solutions to one or more optimization problems for subsections of the payload area, the solutions usable to determine a packing arrangement of the one or more cargo blocks within the one or more containers for each subsection of the payload area.

12. The computer system of claim 11, wherein assigning the one or more cargo blocks to the one or more containers comprises iteratively assigning the one or more cargo blocks to the one or more containers using a knapsack algorithm.

13. The computer system of claim 11, wherein the quantum annealer generates the solutions to the one or more optimization problems based, at least in part, on an objective function that minimizes torque around a center of gravity of the container.

14. The computer system of claim 11, the operations further comprising:
aggregating the one or more solutions to the one or more optimization problems for subsections of the payload area to generate a packing arrangement of the one or more cargo blocks within the vehicle.

15. The computer system of claim 11, the operations further comprising:
defining the one or more optimization problems using a linear programming (“LP”) file;
determining whether to execute the one or more optimization problems using one of the quantum annealer and a high-performance computing (“HPC”) environment based, at least in part, on the one or more constraints wherein:
when determining to execute the one or more optimization problems using the quantum annealer, converting the LP file to a code for the quantum annealer and using the code for the quantum annealer to execute the one or more optimization problems; and
when determining to execute the one or more optimization problems using the HPC environment, converting the LP file to a code for a graphics processing unit (“GPU”) of the HPC environment and using the code for the GPU of the HPC environment to execute the one or more optimization problems.

16. The computer system of claim 11, wherein the subsections of the payload area are determined based, at least in part, on a constraint density of the quantum annealer.

17. A computer storage medium storing computer readable instructions that, when executed by one or more computing devices, cause the computing devices to perform operations, the operations comprising:
accessing cargo block data of one or more cargo blocks, the cargo blocks to be arranged into one or more containers for transport by a vehicle having a payload area;
assigning each cargo block of the one or more cargo blocks to a container of the one or more containers based, at least in part, on one or more constraints;
invoking a quantum annealer to generate one or more solutions to one or more optimization problems for subsections of the payload area, the solutions usable to determine a packing arrangement of the one or more cargo blocks within the one or more containers for each subsection of the payload area; and
aggregating the one or more solutions to the one or more optimization problems to generate a packing arrangement of the one or more cargo blocks in the vehicle.

18. The computer storage medium of claim 17, wherein assigning the one or more cargo blocks to the one or more containers comprises iteratively assigning the one or more cargo blocks to the one or more containers using a knapsack algorithm.

19. The computer storage medium of claim 17, wherein the quantum annealer generates the solutions to the one or more optimization problems based, at least in part, on an objective function that minimizes torque around a center of gravity of the container.

20. The computer storage medium of claim 17, wherein the subsections of the payload area are determined based, at least in part, on a constraint density of the quantum annealer.
